(19) United States
(12) Patent Application Publication
(10) Pub. No.: US 2011/0244589 A1
(43) Pub. Date: Oct. 6, 2011

(54) IN-VIVO PLATELET FUNCTION TEST BY ONLINE BLEEDING VOLUME MEASUREMENT

(76) Inventor: Jeffrey A. Klein, San Juan Capistrano, CA (US)

(21) Appl. No.: 12/899,772

(22) Filed: Oct. 7, 2010

Related U.S. Application Data
(63) Continuation-in-part of application No. 12/579,105, filed on Oct. 14, 2009.

(51) Int. Cl. G01N 21/00; G06K 9/00

(52) U.S. Cl. 436/164; 382/134

(57) ABSTRACT

A method for remotely determining a patient's excessive bleeding tendency and a patient's resistance to blood thinning medication is disclosed. An incision is made in the patient's forearm. Blood oozing out of the incision is absorbed into a blotter paper until the bleeding stops. Blotches of blood formed on the blotter paper are captured as an image and sent to a service provider who calculates a value associated with the bleeding volume of the patient. The service provider retransmits a value associated with the bleeding volume back to the medical professional. To determine the resistance to blood thinning medication, one incision is made in the patient prior to administration of blood thinning medication. Blood oozing out of the incision is collected on blotter paper until the patient stops bleeding. A second incision is made in the patient. A second set of blotter paper is used to collect the blood oozing out of the incision until the bleeding stops. Both sets of blotter paper are sent to a service provider to calculate a value associated with the difference in bleeding volume. The service provider then retransmits the value associated with the difference in bleeding volume to the medical professional.

### CROSS-REFERENCE TO RELATED APPLICATIONS

This application is a continuation-in-part application of U.S. patent application Ser. No. 12/579,105, filed Oct. 14, 2009, the entirety of which is expressly incorporated herein by reference.

### STATEMENT RE: FEDERALLY SPONSORED RESEARCH/DEVELOPMENT

Not Applicable

### BACKGROUND

The present invention relates to a method and apparatus of remotely determining bleeding volume and determining resistance of a patient to blood thinning medication.

There is a need for a general in-vivo screening test for the initial evaluation of patients with respect to possible bleeding disorders. There are several commercially available in-vitro tests which can detect specific single factor aspects of bleeding disorder. However, bleeding disorders are typically multi-factorial and therefore the in-vitro test may not take into account all of the factors involved in evaluating a patient's possible bleeding disorders.

Bleeding disorders may include excessive bleeding tendency. As such, the patient may be susceptible to bleeding during an operation. Preoperative detection of excessive bleeding tendencies would be helpful in determining whether a potential operation would be beneficial to a patient in light of its potential risks.

Bleeding disorders are often associated with platelet dysfunction or imbalance. Platelets, also known as thrombocytes, are the cell fragments circulating in the blood and are involved in the formation of blood clots. Either platelet dysfunction (malfunction) or low level of platelets (low concentration of platelets in the blood) may increase the risk of bleeding, while high levels of platelets may increase the risk of blood clot formation. Platelets are tiny sized fragments derived from megakaryocyte cells in the bone marrow. Platelets contain granules known as dense granules. Dense granules contain adenine diphosphate (ADP), ionized calcium, histamine, serotonin, and epinephrine. When a platelet is activated by contact with injured blood vessels, it degranulates, releasing the contents of the dense granules which cause other platelets to clump together and start the clotting process. As such, it would be beneficial to know whether the patient has a low number of platelets or platelet dysfunction.

Another blood related disorder is related to a patient's resistance to blood thinning (anti-thrombotic or anti-clotting) medication. Resistance to blood thinning medication such as aspirin resistance or aspirin non-responsiveness may be defined as the failure of blood thinning medication (e.g., aspirin) to inhibit platelet function as determined by an in-vitro test (“in a test tube” test). Estimates of the prevalence of aspirin resistance (the estimated percentage of people with aspirin resistance) vary widely among studies and may depend upon the type of platelet function test being used. Estimates of the prevalence of aspirin resistance among healthy patients vary from five (5) percent to fifty (50) percent. Patients who demonstrate aspirin resistance with one test often do not exhibit aspirin resistance with another test. Hence, a need exists for an in-vivo means of assessing drug resistance to anti-thrombotic medications.

The bleeding time of a patient, which is the length of time blood continues to flow after the skin of a patient has been punctured or cut, has been used to identify patients having abnormal bleeding tendencies or platelet dysfunction or low number of platelets. The bleeding time test is an in-vivo test which involves making a standardized incision on the skin then applying a round disc of standardized blotter paper to the enlarging blood droplet adjacent to the incision for precisely thirty (30) seconds, then rotating the blotter paper and applying a fresh edge of the disc to the bleeding incision, and repeating this process until bleeding has stopped. The sequential blotches of blood on the blotter paper should not intersect. The total number of dried blotches of blood on the blotter paper divided by the number two (2) gives the duration of bleeding in minutes.

For many years the bleeding time test was widely used as a pre-surgical test to predict the risk of excessive surgical bleeding. However, based on several comprehensive reviews in the 1990's, the bleeding time test is now regarded as insensitive and has been largely abandoned as a routine pre-operative clinical test. Nevertheless, the bleeding time test remains the only readily available in-vivo test for platelet function or inadequate platelet numbers. One criticism of the bleeding time test is that it has insufficient sensitivity and specificity. For example, it is often desirable to avoid surgery on a patient who is taking aspirin because of the risk of excessive surgical bleeding. The mean bleeding time of persons who take aspirin and those that take no medication do not differ by more than two (2) standard deviations. Thus, the bleeding time test cannot reliably distinguish between persons who take aspirin and those who do not.

Moreover, there are several factors which can affect the results and consistency of a bleeding time test including Von Willebrand Disease, alcohol, temperature, cirrhosis, and renal insufficiency. Mild systemic hypothermia also influences platelet adhesion and aggregation and coagulation reaction. Bleeding time is also sensitive to alterations of skin temperature. By way of example and not limitation, lowering the skin temperature from thirty-two (32) degrees Celsius to between thirty (30) degrees Celsius and twenty-eight (28) degrees Celsius with a preserved core temperature can more than double the bleeding time. Hence, the bleeding time test does not appear to be a reliable test in determining a patient's potential bleeding disorder or platelet dysfunction or inadequate platelet numbers.

Aspirin is believed to be very effective in preventing acute myocardial infarction and major stroke. As a result of multiple clinical trials demonstrating the anti-platelet and antithrombotic effect of aspirin, it is now the primary treatment for prevention of heart attack and stroke. However, there is recent evidence that some subset of the population is resistant to the beneficial effects of aspirin. Patients with aspirin resistance who take aspirin prophylactically may not receive a significant benefit yet are exposed to the risk of aspirin side effects such as gastric irritation or erosion.

Current in-vitro diagnostic clinical laboratory devices for detecting the conditions discussed above may cost more than $9,000 plus disposable supplies. The costs to operate these devices may include waste due to expired perishable reagents, expensive cartridges and/or other expensive disposable supplies. As such, barriers to entry exist for these current devices. Moreover, in remote and/or impoverished areas of the world, purchasing, installing and operating such an expensive device may be cost inefficient. As such, medical professionals in these areas may treat patients without the benefits and additional information which may be necessary to properly treat the patient.

For the foregoing reasons, there is a need in the art for an improved in-vivo test to determine both excessive bleeding tendencies of a patient and resistance to blood thinning medication.

### BRIEF SUMMARY

A medical professional in a remote location can now determine a patient's bleeding tendency as long as the medical professional has the means of capturing an image and transmitting the captured image to a service provider who calculates a value associated with the bleeding volume then retransmits (i.e., returns) such value back to the medical professional. The medical professional may use the value associated with the bleeding volume to make an educated treatment decision for that particular patient. In particular, the medical professional performs a traditional bleeding time test by making an incision on the forearm of the patient while a blood pressure cuff is mounted to an upper arm portion of the patient and set to a predetermined pressure (e.g., 40 mm Hg). Once the incision is made, blood will ooze out of the incision. Blotter paper is used to absorb accumulating blood adjacent the incision. Every thirty (30) seconds or at every predetermined time interval, the blotter paper is rotated and a clean fresh unused edge of the blotter paper absorbs the accumulating blood such that the absorbed blotches of blood do not intersect. This process is continued until blood stops oozing out of the incision. The surface area of the blotches of blood formed on the blotter paper has a linear relationship with the volume of blood. The medical professional may now capture (e.g., scan, photograph, digitize, digitally capture, etc.) the blotter paper with blotches formed thereon and transmit the captured image to the service provider (e.g., internet based server, database server, medical service provider, etc.) who will then calculate a value associated with the bleeding volume of the patient. The service provider will then transmit the value associated with the bleeding volume back to the medical professional such that the medical professional may now make an educated treatment decision for that particular patient.

A method of determining a resistance score of a patient's resistance to blood thinning medication is also disclosed. In particular, a medical professional performs one or more bleeding volume tests on the same patient on two separate occasions as discussed herein, once before the patient receives a blood thinning medication and again after the patient has been given the blood thinning medication. Two sets of blotter papers are collected. The first set represents blood gathered from the patient while the patient does not have blood thinning medication within his/her system. The second set of blotter paper represents blood gathered from the patient after administration of a blood thinning medication. The two sets of blotter papers are transmitted to a service provider who calculates a value associated with a difference in or ratio of some mathematical function of the bleeding volumes of the patient before and after administration of blood thinning medication. The value is then transmitted back to the medical professional such that the medical professional may now make an educated treatment decision for that particular patient.

More particularly, in an embodiment, a method for determining bleeding volume of a patient at a remote location is disclosed. The method may comprise the steps of breaking the skin of the patient to induce bleeding, absorbing blood of the patient on a flat absorbent material until the patient stops bleeding, providing a reference surface area on the flat absorbent material, scanning an image of the flat absorbent material including blotches of the absorbed blood and the reference surface area, transmitting the scanned image to a service provider, and receiving a value associated with the bleeding volume of the patient from the service provider.

The breaking the skin of the patient may include the step of making an incision on the skin of the patient. The flat absorbent material may be a standard blotter paper for conducting a bleeding time test. The scanning step may include the step of creating a portable document file or picture file of the flat absorbent material. The transmitting step may include the step of emailing the scanned image to the service provider. The scanning step and the transmitting step may include the step of faxing an image of the flat absorbent material to the service provider.

In another embodiment, a method for determining bleeding volume of a patient at a remote location is disclosed. The method may comprise the steps of receiving a scanned image of a flat absorbent material including absorbed blood of the patient and a reference surface area, determining the area of absorbed blood, determining a value associated with the bleeding volume of the patient as a function of the area of absorbed blood and the reference surface area, and transmitting the value to the remote location.

The determining the area of the absorbed blood step may include the steps of determining a number of pixels within a digital photograph of the absorbed blood on the flat absorbent material, determining a number of pixels of the reference surface area, and dividing the number of pixels of the absorbed blood by the number of pixels of the reference surface area.

The transmitting step may include the step of faxing, emailing, transmitting over the internet, refreshing a website accessed from the remote location, or transmitting a digital photograph by way of a mobile (cellular) telephone.

In another embodiment, a method of determining resistance of a patient to blood thinning medication is disclosed. The method may comprise the steps of breaking a skin of the patient to induce bleeding prior to administering blood thinning medication, absorbing the blood of the patient on a first flat absorbent material until the patient stops bleeding, administering the blood thinning medication to the patient, breaking the skin of the patient to induce bleeding after administering the blood thinning medication to the patient for a period of time so that the blood thinning medication achieves maximum effect, absorbing the blood of the patient on a second flat absorbent material until the patient stops bleeding, transmitting one or more images of the first and second flat absorbent material to a service provider, and receiving a value associated with a difference or ratio in bleeding volume prior to and after administration of the blood thinning medication from the service provider based on the one or more images of the first and second flat absorbent material.

The administering step may include any means of drug delivery such as the step of injecting the patient with the blood thinning medication or directing the patient to orally ingest the blood thinning medication.

In another embodiment, a method of processing a standard sized blotter paper with blotches of blood to derive a value indicative of a bleeding volume of a person is disclosed. The method may comprise the steps of electronically imaging a single two dimensional view of the blotches of blood formed on a first standard sized blotter paper; determining a pixel to surface area ratio based on the first blotter paper's standard size and the imaged first blotter paper; determining the number of pixels formed by the blotches of blood on the first blotter paper; and dividing the number of pixels of the blotches of blood on the first blotter paper by the pixel to surface area ratio to derive the value indicative of the bleeding area or volume of the person based on the first blotter paper.

The determining steps and the multiplying steps may be performed with a processor. The method may further comprise the step of receiving the value indicative of bleeding volume. In the electronically imaging step, the same may include the step of photographing the first blotter paper with the blotches of blood thereon. In the determining step, the same may include the steps of determining a number of pixels of the electronically imaged standardized first blotter paper and dividing such number by a known area of the standard sized first blotter paper. In the step of determining the pixel to surface area ratio, the same may include the steps of determining a ratio defined as a value associated with an area of the imaged blotter paper over a value associated with an area of the standard sized blotter paper; and multiplying the ratio by the number of pixels formed by the blotches of blood on the blotter paper. The imaging step, the determining steps and the multiplying steps may be performed on a handheld electronic device. The handheld electronic device may be a personal digital assistant or a mobile telephone having a digital camera or a similar device. In relation to the determining the pixel to surface area ratio step, the same may include the step of aligning an electronic image of the standard sized first blotter paper to a predefined outline or reticule shown on the view-screen during the imaging step on a screen of an electronic device.

The method may further comprise the steps of electronically imaging one two dimensional view of the blotches of blood formed on a second standard sized blotter paper; determining a pixel to surface area ratio based on the second blotter paper's standard size and the imaged second blotter paper; determining the number of pixels formed by the blotches of blood on the second blotter paper; and dividing the number of pixels of the blotches of blood on the second blotter paper by the pixel to surface area ratio to derive the value indicative of the bleeding volume of the person based on the second blotter paper. The blotches of blood on the first and second blotter papers may represent first and second control discs for a screening in vivo platelet function test. Alternatively, the blotches of blood on the first blotter paper may represent a first control disc, and the blotches of blood on the second blotter paper may represent a first drug disc for determining a value associated with a difference in bleeding volume before and after drug consumption.

In another embodiment, an apparatus for processing a standard sized blotter paper with blotches of blood to derive a value indicative of a bleeding volume of a person is disclosed. The apparatus may comprise an electronic device with a program comprising the steps of: electronically capturing a single two dimensional image of the blotches of blood formed on the standard sized blotter paper; determining a pixel to surface area ratio based on the blotter paper's standard size and the imaged blotter paper; determining the number of pixels formed by the blotches of blood on the blotter paper; dividing the number of pixels of the blotches of blood on the blotter paper by the pixel to surface area ratio to derive the value indicative of the bleeding volume of the person.

The electronic device may be a computer, portable electronic device, personal digital assistant, a camera or combination thereof. The electronic device may have a screen and the program may form an outline of the blotter paper on the screen.

In another embodiment, a method of processing a standard sized blotter paper with blotches of blood to derive a value indicative of a bleeding volume of a person is disclosed. The method may comprise the steps of receiving an electronically imaged single two dimensional view of the blotches of blood formed on a first standard sized blotter paper; determining a pixel to surface area ratio based on the first blotter paper's standard size and the imaged first blotter paper; determining the number of pixels formed by the blotches of blood on the first blotter paper; dividing the number of pixels of the blotches of blood on the first blotter paper by the pixel to surface area ratio to derive the value indicative of the bleeding volume of the person; and delivering the value indicative of the bleeding volume of the person to a medical professional.

In relation to the delivering step, the method may include the step of emailing or providing a unique identifier to the medical professional so that the medical professional may look up the value indicative of bleeding volume of the person online.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a blotter paper absorbing blood oozing out of an incision on a forearm of a patient;

FIG. 2 illustrates one or more blotter papers with blotches of blood on the blotter paper shown in FIG. 1;

FIG. 2A illustrates a blotter paper with a known quantity of blood absorbed into the blotter paper forming a blotch of blood;

FIG. 3 illustrates a process of remotely obtaining a value associated with a patient's bleeding volume;

FIG. 4 illustrates a process of determining a patient's resistance to blood thinning medication;

FIG. 5 illustrates a process of remotely obtaining a resistance score associated with a patient's resistance to blood thinning medication;

FIG. 6 is a side view of a camera stand and camera for taking pictures of one or more blotter papers;

FIG. 7 is an illustration of an electronic display of the camera shown in FIG. 6;

FIG. 8 is a first screenshot of a bleeding volume application downloaded onto a smart phone;

FIG. 8A illustrates a separate paper on which is formed a known standard (e.g., four lines arranged as a square);

FIG. 8B illustrates the separate paper shown in FIG. 8A with a blotter paper laid within the known standard or four lines shown in FIG. 8A;

FIG. 8C illustrates the separate paper shown in FIG. 8A with the blotter paper laid adjacent to the known standard or four lines shown in FIG. 8A;

FIG. 9 is a second screenshot of the bleeding volume application;

FIG. 10 is an overview of the phone wirelessly communication with a back end server;

FIG. 11 is a results page of the bleeding volume application; and

FIG. 12 is a flow chart for a screening platelet function test with online assistance.

### DETAILED DESCRIPTION

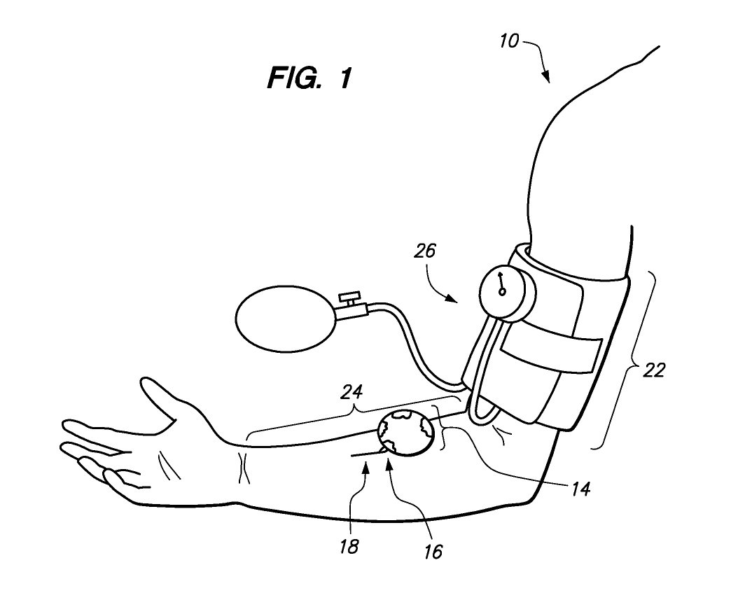

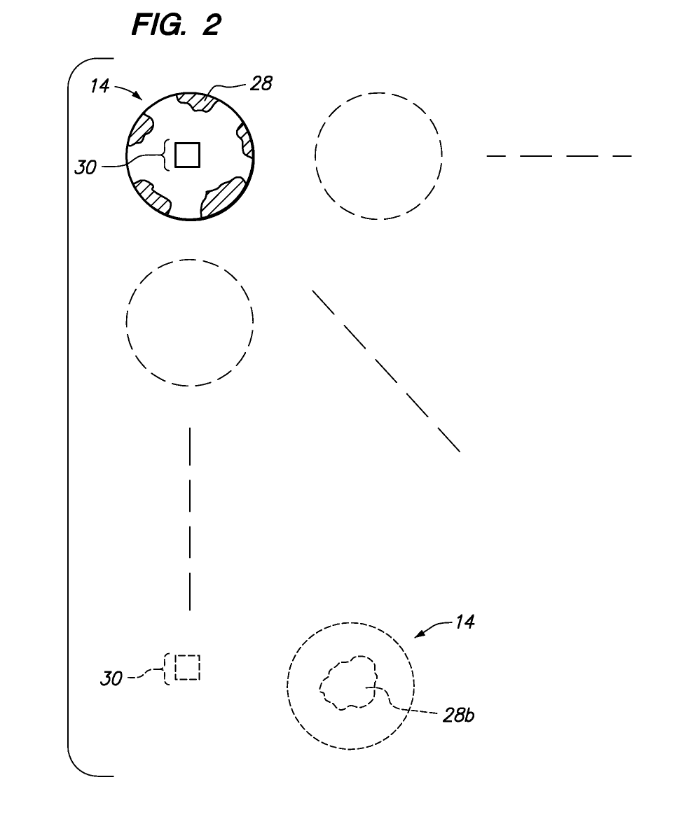

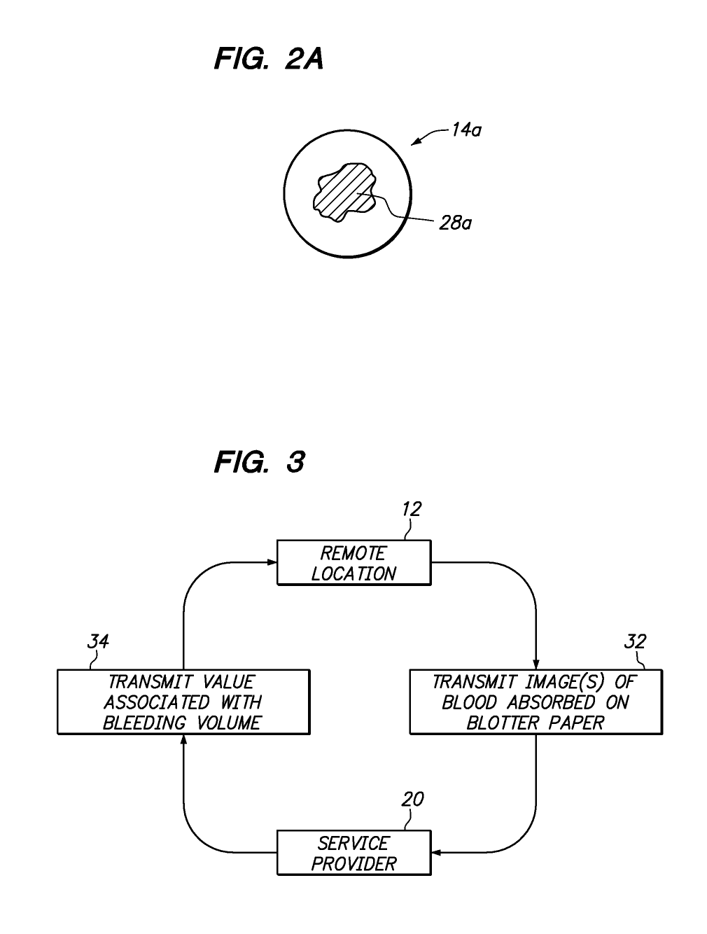

Referring now to the drawings, a method for determining bleeding volume of a patient 10 at a remote location 12 is disclosed. Bleeding volume is the volume of blood lost during a bleeding time test. Bleeding time is a total length of time between the moment a standardized tiny superficial incision is made in the skin of a patient and the moment the bleeding stops. As shown in FIG. 1, the edge of a blotter paper 14 is used to absorb discrete blotches of blood 16 oozing out of an incision 18 during sequential thirty (30) second time intervals. The blotter paper 14 absorbs the blood 16 oozing out of the incision 18 until the patient 10 stops bleeding. One or more blotter papers 14 may be necessary to absorb all of the blood 16. The blotter paper(s) 14 (see FIG. 2) may be scanned as an image and transmitted 32 to a service provider 20, as shown in FIG. 3. The service provider 20 may be an internet server, database server, a group of medical professionals or a business that provides the calculations, transmissions, information reception and other services discussed herein in relation to the role of the service provider. By way of example and not limitation, the service provider 20 may refer to a website accessible over the internet. The website may provide a means to upload scanned image and submit the scanned image thereby transmitting the scanned image to the service provider 20. The back end of the website may automatically calculate information based on the scanned image and re-transmit information back to the medical professional. Alternatively, the service provider may be a group of technicians or the like that receive the uploaded scanned images, performs calculations and retransmits information back to the medical professional. As such, the service provider may be anyone, device or combination that performs at least one of the functions (e.g., calculates, receives or retransmits information) regarding the service provider discussed herein.

The service provider 20 receives the scanned image and calculates a total blood volume or other bleeding volume based value (e.g., bleeding rate) based on a surface area of the discrete blotches of absorbed blood 16 on the blotter paper 14 to volume of absorbed blood relationship as discussed in U.S. Pat. No. 7,364,545, the entire contents of which is expressly incorporated herein by reference. The surface area of the discrete blotches 28 of absorbed blood is shown hatched in FIG. 2. The in-vivo bleeding volume test results of the patient 10 is indicative of a patient's excessive bleeding tendencies, platelet function and platelet number. Bleeding volume is more sensitive than bleeding time in detecting abnormal platelet function because 1) bleeding volume is a continuous variable whereas bleeding time is discrete variable. Bleeding volume is more specific than bleeding time in detecting abnormal platelet function because in most clinical situations the volume of bleeding is more important than the duration of bleeding. The service provider 20 transmits 34 (see FIG. 3) the bleeding volume based value back to the medical professional at the remote location 12. A medical professional treating the patient 10 at the remote location 12 is now capable of determining the patient's excessive bleeding tendencies, etc. as long as the medical professional has access to an electronic device which take and transmit photographic images to the service provider 20 or a digital scanner and a means for transmitting the scanned image to the service provider 20 such as through the internet.

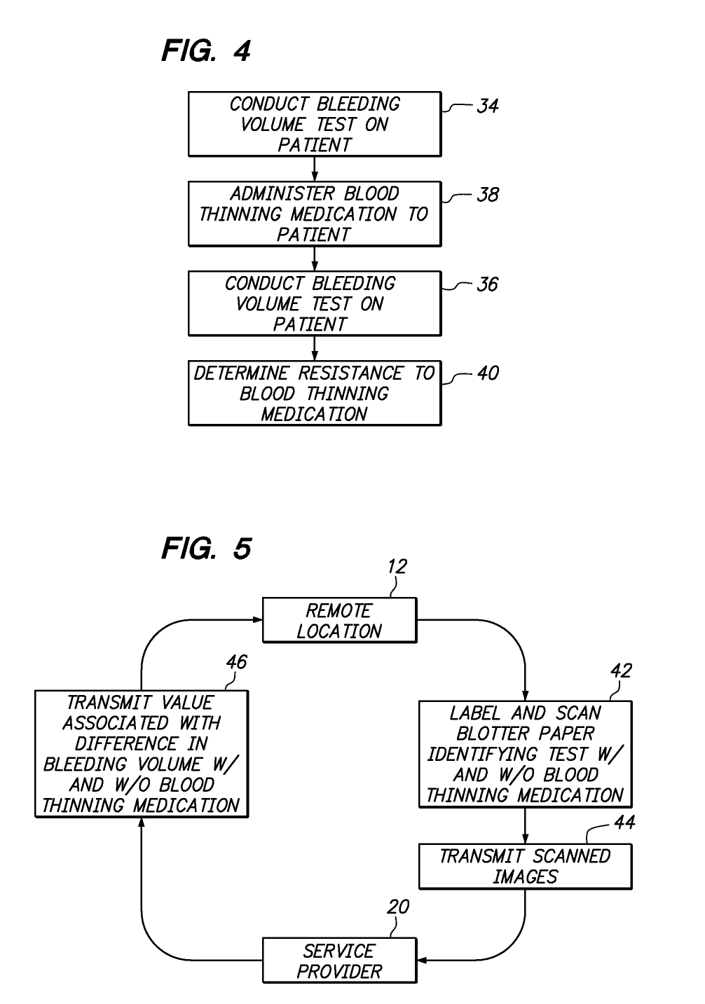

FIGS. 4 and 5 illustrate a method for determining a patient's resistance to a blood thinning medication (e.g., aspirin). By way of example and not limitation, the blood thinning medication may be aspirin, the ADP P2Y₁₂ receptor blocker: clopidogrel, GPIIb-IIIa antagonists: abciximab, tirofiban and eptifibatide, lidocaine, statins (HMG-CoA reductase inhibitors), flaxseed oil, etc. As shown in FIG. 1, an incision 18 is made on a patient 10 prior to any administration of a blood thinning medication to the patient 10. A first pretreatment control set of blotter paper 14 is used to absorb the blood 16 oozing out of the incision 18 until the bleeding stops. Blood thinning medication is now administered to the patient 10. After a period of time has elapsed to allow the blood thinning medication to reach its maximum effect on the patient 10, a post-treatment second incision 18 is made on the patient 10. A second clean set of blotter paper 14 absorbs the blood 16 oozing out of the second incision 18 until the patient stops bleeding. One or more images of the first and second sets of blotter papers 14 may be transmitted to a service provider 20. The service provider may calculate or determine a value associated with the difference or ratio in the bleeding volume and bleeding time or some function of the patient 10 before and after administration of the blood thinning medication. The service provider 20 may then transmit such value or values back to the medical professional at a remote location. In this situation, the effect of an antiplatelet drug on bleeding volume is more pronounced than the effect of an antiplatelet drug on bleeding time. For example, taking an aspirin will increase the bleeding time by 72% while aspirin increases bleeding volume by 400%. Thus when assessing a drug's effect on platelet function bleeding volume is more sensitive than bleeding time.

The value (e.g., difference or ratio of some function of the bleeding volume and bleeding time before and after administration of the blood thinning medication) may be used to gauge the patient's resistance to the blood thinning medication. The medical professional can now make an educated decision as to whether prescribing the blood thinning medication to the patient 10 would be beneficial in light of the risk of the blood thinning medication. Also, since a patient's resistance to blood thinning medication is multi-factorial with possible explanatory factors including multiple genes, variable degrees of blood thinning medication affinity to platelet surface binding sites, variable degrees of cyclooxygenase binding and interaction with blood thinning medication (e.g., aspirin) and variable degrees of blood thinning medication (e.g., aspirin) bioavailability and metabolism, the test described herein is an in vivo test so as to take into consideration the multi-factorial factors to blood thinning medication resistance. Additionally, the methods and apparatus described herein allows a medical professional at a remote location to gauge the patient's excessive bleeding tendency and blood thinning medication resistance as long as the medical professional has access to either a cellular telephone having a digital camera or a scanner and a means for transmitting the scanned image to the service provider 20 such as through the internet for the purpose of better treating a particular patient.

The method and system disclosed herein may be less expensive, have fewer moving parts, be more accessible almost anywhere in the world and is an in-vivo compared to an in-vitro test. Some of the desirable features include but are not limited to the following. The method and system may be less expensive than current diagnostic clinical laboratory devices which, as discussed in the background, may cost more than $9,000 plus the disposable supplies. The method and system disclosed herein does not require a large capital expenditure and therefore is more readily available for use by impoverished clinics in underdeveloped countries or isolated communities. The test may also be available twenty-four (24) hours a day, seven days a week and three-hundred-sixty-five (365) days a year since an embodiment of the method and system contemplates an internet based or supported test. No perishable reagents, expensive cartridges or other expensive disposable supplies are necessary for implementing the method and system disclosed herein. A blotter paper, scanner and means of communication with the service provider 20 may be all that is necessary for implementing the method and test disclosed herein. The service provider 20 provides the backend support to reduce the frontend costs to the medical professional at the remote location. In a different embodiment, the method and test may be implemented with an image capture device (e.g., camera, smart phone, etc.) and software loaded on the smart phone or computer. The method and system disclosed herein also does not require puncture of a vein (phlebotomy) for obtaining a blood sample which in some patients may be problematic. Many older patients and obese patients may have inaccessible veins. Since an embodiment of the method and system disclosed herein is an online platform with which medical professionals interact, the same allows an easy creation of a clinical database for collecting and storing large amounts of data as well as proper security and confidentiality. Additionally, the online aspect of the procedure and device or system allows continual updating of clinical databases containing a wide variety and large number of clinical covariates (i.e., associated common medical conditions and rare diseases). This allows every participating clinician or medical professional to compare an individual patient to a highly relevant set of patients with similar co-morbidities. This may significantly increase the test's sensitivity and specificity.

The online bleeding volume test allows for the screening of platelet dysfunction, diagnostic test for diseases of platelet dysfunction, Von Willebrand Disease, monitoring anti-platelet therapy with anti-platelet drugs such as aspirin, clopidogrel, test of compliance, predicting bleeding, detecting platelet hyperfunction and prediction of thrombosis, platelet function testing in transfusion medicine. By way of example and not limitation, the patient's system is cleared of any drug (e.g., aspirin, etc.) that might affect the bleeding volume. The medical professional may instruct the patient to not take aspirin for ten (10) days prior to the test. Upon clearing the patient's system, a bleeding volume baseline value is determined for the patient by performing the bleeding volume test discussed herein. Additionally, the website supporting the online bleeding volume test may facilitate large prospective studies so that the patient's results may be compared to a greater sample of patients. It is also contemplated that a patient's bleeding volume may be correlated with certain factors or covariates such as race, age, prior health disorders, etc.

Referring now to FIG. 1, a medical professional conducts the following procedure on the patient 10 being treated. The conditions for consistent blood flow and clotting may be set up. For example, the incision area may be wiped with alcohol which is allowed to completely dry. The patient may either sit in a chair with the forearm in a comfortable stable position or reclining with the forearm at heart level. A blood pressure (e.g., sphygmomanometer) cuff 26 may be placed on an upper arm 22 of the patient 10. By way of example and not limitation, the blood pressure cuff 26 may be inflated to about 40 mm Hg to regulate a constant venous blood pressure in the forearm 24 of the patient 10. After the blood pressure of the patient's forearm 24 is stabilized, which typically takes no more than thirty seconds, a standard dermal incision 18 (e.g., 5 mm long and 1 mm deep) is made in the skin of the volar forearm 24 of the patient 10. A round disc blotter paper 14 typically used for determining bleeding time may be placed at the edge of the incision 18. Preferably, the blotter paper does not touch the incision so that blood clot formation is not disturbed. The blood 16 from the wound is wicked onto the edge of the blotter paper 14. At the end of each thirty second interval, the blotter paper 14 may be rotated slightly and a clean unused edge of the blotter paper 14 is gently touched to the edge of the accumulating droplet of blood 16 at the incision site 18 taking care that adjacent blotches of blood do not intersect. One or more blotter papers 14 may be necessary to absorb all of the blood 16 oozing out of the incision 18. When the bleeding stops, the blood pressure cuff 26 is removed from the patient 10 and the incision 18 is cleaned and bandaged as clinically indicated. The same procedure may be conducted on the patient's other arm and the results averaged. Excessive bleeding volume when compared to the norm may indicate an undesirable medical condition. Additionally, the same test may be conducted on one or both forearms of the patient after the patient has ingested a drug (e.g., aspirin, etc.) and after a period of time (e.g., 1 hour) has elapsed to allow the drug to be absorbed into the patient's system for the purpose of testing for a patient's resistance to the drug or benefit to the patient if prescribed the drug.

The following are some sources of error when conducting the bleeding volume test and deriving a value based on the bleeding volume or difference in bleeding volume. The patient may have taken aspirin or aspirin-containing compounds 7-10 days prior to the procedure. The bleeding time may be prolonged and the bleeding volume may be excessive. Results may also be affected by an improperly performed puncture. The puncture should not be too shallow, too deep or at an inappropriate location. Prior to puncturing the skin of the patient, alcohol is wiped on the skin to sterilize the area. However, if the alcohol is incompletely dry before making the puncture, then the residual alcohol may prolong the bleeding time or produce excessive bleeding. The bleeding time may be calculated by counting the number of blotches and dividing by 2 which yields the Bleeding Time expressed in minutes. Other sources of error include a blood pressure cuff maintained too high, and low fibrinogen concentration or low platelet count.

In evaluating a patient's risk of excessive bleeding, if a patient has no personal or family history of excessive bleeding, then it is recommended that no further laboratory tests be conducted. If a clinical history of the patient reveals possible association with excessive bleeding within the immediate family, or personal history of excessive bleeding following trauma or surgery, or if there is a history of transfusions then further testing may be warranted. The initial screening test for coagulation defects include (Prothrombin Time (PT), Activated Partial Thromboplastin Time (aPTT), platelet count, factor VIII, Von Willebrand antigen, ristocetin factor, and if these tests are negative, then platelet aggregation testing may be conducted. The medical professional should also review relative contraindications such as history of keloid formation and active cutaneous infection.

As shown in FIG. 2, the blood 16 absorbed into the blotter paper 14 creates blotches 28 of absorbed blood 16. The aggregated surface area of the blotches 28 formed on the one or more blotter papers 14 during the procedure described above correspond to the bleeding volume. Bleeding volume is defined as the volume of blood that oozes out of the incision 18 from the moment an incision 18 is made to the moment the bleeding stops. The number of blotches 28 is an estimate of the bleeding time. Bleeding time is defined as the total length of time between the moment the incision 18 is made and the moment the bleeding stops. In particular, two blotches 28 of absorbed blood correspond to one minute. To calculate the total bleeding time, the number of blotches 28 may be counted and divided by two to arrive at the bleeding time to the nearest thirty (30) second interval. Alternatively, the bleeding time may be calculated with a stopwatch.

To determine the bleeding volume based on the blotches 28 formed on the blotter paper 14, the one or more blotter papers 14 may be scanned as a JPEG (joint photographic experts group) file and emailed 32 (see FIG. 3) to a service provider 20. The service provider 20 then takes the scanned image and determines the bleeding volume. In particular, when the medical professional scans the one or more blotter papers 14, a reference area 30 may be formed on (see solid line in FIG. 2) or alongside (see dash line in FIG. 2) the one or more blotter papers 14. The reference area 30 may be for example 1 cm². When the service provider 20 receives the scanned image, the service provider 20 may determine the number of pixels forming the reference area 30 (i.e., pixels to surface area conversion ratio). With this information, the service provider 20 may determine the number of pixels per centimeter squared or its inverse. The service provider 20 may also determine the number of pixels forming the blotches 28. The number of pixels forming the blotches 28 on the blotter papers 14 may be divided by the pixels per centimeter squared (pixel to surface area conversion ratio) determined above. This results in the total surface area in centimeter squared of the blotches 28.

With the total surface area of the blotches 28, the service provider 20 may now calculate the total blood volume of the blood forming the blotches 28. To this end, the service provider 20 may take a known volume of blood 16 (e.g., 30 micro liters) and drop the known volume (e.g., 30 micro liters) of blood 16 on blotter paper 14a which may be the same or similar type of blotter paper 14 used by the medical professional. This is shown in FIG. 2A. The service provider 20 can calculate the area of the blotch 28a and determine the surface area per volume or volume per surface area of blood 16 (i.e., area/volume conversion ratio) because there is a linear correlation between the volume of blood and the surface area of the blotch 28a. The service provider 20 may then divide the total surface area of the blotches 28 shown in FIG. 2 by the area/volume conversion ratio determined by the service provider 20. This produces the total volume of blood representing the bleeding volume of the patient 10. The bleeding volume of the patient 10 can now be transmitted back to the medical professional to further aid the medical professional in diagnosing the patient 10.

Instead of the service provider 20 determining the area/volume conversion ratio, the medical professional may aid the service provider 20 in doing so. In particular, the medical professional may utilize an additional blotter paper 14 and drop a known quantity of blood 16 of the patient treated on the blotter paper 14 to form blotch 28b, as shown in FIG. 2 in dash lines. The blotter paper 14 along with the blotch 28b may be scanned alongside the one or more blotter papers 14. The blotter paper 14 with blotches 28, the blotter paper 14 with blotch 28b and the reference surface area 30 may be scanned and transmitted to the service provider 20. The service provider 20 calculates the bleeding volume based on (1) the total surface area formed by the blotches 28, (2) the pixels to surface area conversion ratio) and (3) the area/volume conversion ratio determined by blotch 28b, as discussed above. The service provider 20 may then retransmit 34 the bleeding volume to the medical professional.

Referring now to FIG. 3, a general overview of the process is shown. The medical professional may be at a remote location 12. The remote location 12 may be a location other than the location of the service provider 20. For example, the remote location 12 may be across town, in a different state, in a different country. The medical professional conducts the procedure discussed above with the incision 18 and the blotter paper 14 at the remote location 12. The blotter paper 14 with blotches 28 may be scanned as an image (e.g., JPEG file) and emailed to the service provider 20. Alternatively, the blotter papers 14 may be photocopied and faxed to the service provider 20. The copying and faxing of the blotter paper 14 alters the scaling of the blotches 28 and 28a, b. However, the reference surface area 30 also changes a corresponding amount. As such, the service provider 20 may determine the bleeding volume based on the faxed 32 blotter papers 14. By way of example and not limitation, the service provider 20 may scan in the fax to determine (1) the number of pixels of the aggregate blotches 28, (2) pixels to surface area conversion ratio and (3) the area per volume conversion ratio to ultimately calculate the bleeding volume. Once the service provider 20 determines the bleeding volume of the patient 10, the bleeding volume is then transmitted 34 back to the medical professional at the remote location 12. With this information, the medical professional may make a better treatment decision for that particular patient.

Generally, the service provider 20 transmits a value associated with the bleeding volume. By way of example and not limitation, such value may be the bleeding volume, bleeding time and/or bleeding rate. The bleeding rate is defined as the bleeding volume divided by the bleeding time. The value may be represented as a continuous variable in the real numbers, or a discrete subset of the integers. It is also contemplated that the value may be represented as a dichotomous score such as yes/no, sick/well, condition present/absent. Also, the value may be a categorical score such as a number from one (1) to ten (10) wherein one (1) through three (3) represents minimal bleeding tendencies, a number between four (4) through seven (7) represents an average bleeding tendency, and a number eight (8) through ten (10) represents excessive bleeding tendencies. The medical professional may use this value associated with bleeding volume to further diagnose and treat the patient 10.

It is also contemplated that the value associated with the bleeding volume may be derived without calculating the total surface area of the blotches 28. In particular, a number of pixels for all of the blotches 28 is determined from the image file (e.g., JPEG file) provided by the medical professional or by scanning in a fax of the blotter paper 14 and calculating the number of pixels forming the blotches 28. The service provider 20 may calculate the number of pixels forming the blotch 28b of a known volume of blood. The service provider 20 divides the total number of pixels of the blotches 28 by the pixels of the blotch 28b the known volume of blood to derive the total bleeding volume. A value associated with the bleeding volume may be transmitted back to the medical professional such that the medical professional may make a better treatment decision for a particular patient.

Referring now to FIG. 4, a method for determining a blood thinning medication resistance score is shown. In particular, the bleeding volume test of the patient 10 is conducted 34, 36 before and after blood thinning medication is administered 38 to the patient 10. A difference in bleeding volume is determined 40 and used to indicate the patient's resistance to the blood thinning medication. If the patient 10 is resistant to the blood thinning medication, then the blood thinning medication would provide marginal or no benefit to the patient 10 in preventing acute myocardial infarction and/or major stroke yet expose the patient 10 to harmful side effects (e.g., gastric irritation or erosion) of the blood thinning medication. Conversely, if the patient 10 is not resistant to the blood thinning medication, then the benefit received by the patient in preventing acute myocardial infarction and major stroke may outweigh the harmful side effects of the blood thinning medication. By way of example and not limitation, aspirin (a blood thinning medication) has been shown to be effective in preventing acute myocardial infarction and major stroke. However, aspirin may produce side effects such as gastric irritation or erosion. If the patient 10 receives marginal or no benefit in preventing acute myocardial infarction and major stroke by taking aspirin, then there would be little incentive to prescribe a regimen of aspirin since the patient 10 would be exposed to side effects of aspirin such as gastric irritation and erosion without significant benefit. On the other hand, if the patient 10 is not resistant to blood thinning medication, then it may be beneficial to the patient 10 to take blood thinning medication in preventing acute myocardial infarction and major stroke even though the patient 10 is exposed to side effects of the blood thinning medication. Generally, the greater the difference in bleeding volume before and after administration of blood thinning medication indicates less resistance to the blood thinning medication. Conversely, the smaller the difference in bleeding volume before and after administration of the blood thinning medication, then the greater the resistance to the blood thinning medication and less benefits are received by the patient 10 in preventing acute myocardial infarction and/or major stroke.

The blood thinning medication resistance score (hereinafter “RS”) may be characterized as a numerical quantification of the relative degree of resistance to blood thinning medication by the patient 10. To derive the numerical quantification, the bleeding volume test is conducted 34 on the patient 10 prior to administration of the blood thinning medication to the patient 10. Moreover, the medical professional may require that the patient 10 cleanse his/her system from prior doses of blood thinning medication (e.g., aspirin). By way of example and not limitation, the medical professional may instruct the patient 10 to not take aspirin or other blood thinning medications for about one to two weeks. When the patient 10 has cleared his/her system from all blood thinning medication, the medical professional conducts 34 the bleeding volume test on the patient 10. In particular, a blood pressure cuff 26 is placed on the upper arm 22 of the patient 10. The pressure may be set to about 40 mm Hg. The blood pressure in the arm of the patient is stabilized and a standard dermal incision 18 may be made on the forearm 24 of the patient 10. Blotter paper 14 is placed adjacent the accumulating droplets of blood 16 forming adjacent the incision 18. The blotter paper 14 absorbs the blood 16 and forms a blotch 28 of blood 16 on the blotter paper 14. Every thirty seconds, the blotter paper 14 may be rotated such that a clean edge of the blotter paper 14 is used to absorb the accumulating droplets of blood 16 adjacent the incision 18. This process is continued until the patient 10 stops bleeding. This set of blotter paper 14 with blotches 28 is properly identified (e.g., PRIOR TO ASPIRIN ADMINISTRATION) and may be scanned as a single image file (e.g., JPEG file). A second “before-aspirin” bleeding volume test procedure may also be conducted on the patient's other arm. If so, the two sets of blotter paper are acquired. Also, the results may be averaged.

The blood pressure cuff 26 is removed from the patient 10. The patient 10 is then directed to ingest 38 a quantity of blood thinning medication (e.g., 325 mg of aspirin). The medical professional may wait approximately one hour or some other period of time before conducting 36 the bleeding volume test of the patient. The one hour time period allows the blood thinning medication to reach its peak effect on the patient. When the bleeding volume test is conducted 36 on the patient after ingestion, the difference in bleeding volume prior to and after administration of the blood thinning medication is at its maximum. After the blood thinning medication has reached its maximum effect on the patient 10, the medical professional conducts 36 the bleeding volume test on the patient 10 so as to produce a set of blotter papers 14 with blotches 28 formed by the blood 16 oozing out of the incision 18 of the patient 10. The “after-aspirin” bleeding volume test can also be conducted another time on the patient's other arm. The results of the two sets of blotter paper may be averaged. The sets of blotter paper 14 may be properly labeled and scanned 42 along with a reference area 30. Optionally, a blotch 28b of a known volume of blood 16 of the patient 10 may be formed on a separate blotter paper 14 such that the service provider 20 may determine the pixels per volume conversion ratio and/or surface area per volume conversion ratio. The scanned images are then transmitted 44 to the service provider 20.

The service provider 20 calculates a value associated with a difference in the bleeding volume. In particular, for each of the sets of blotter paper 14, the bleeding volume of the patient 10 may be determined as discussed above. The number of pixels forming the blotches 28 on the blotter paper 14 may be determined. The number of pixels forming the reference surface area 30 may be calculated. The number of pixels forming the blotches 28 for the set of blotter paper 14 may be divided by the number of pixels forming the reference surface area 30 to arrive at the total surface area of the blotches 28 for the set of blotter paper 14. The total surface area 30 of the blotches 28 of the set of blotter paper 14 may be divided by the area per known volume of blood determined by the blotch 28a or 28b (see FIGS. 2 and 2A). This derives the bleeding volume of the patient 10 prior to administration of the blood thinning medication. The same calculation may be conducted for the other sets of blotter paper 14 to arrive at the bleeding volume of the patient 10 after administration of the blood thinning medication. The service provider 20 transmits 46 the value back to the medical professional. The value may be the blood thinning medication resistance score or RS. As previously stated, the medical professional may be located at a remote location 12 such as across town, in a different state, in a different country. As long as the medical professional has access to a scanner and a means for transmitting the scanned images (e.g., fax, internet, email, etc.), the medical professional may obtain more information about the patient he/she is treating to make an educated treatment decision for a particular patient.

The RS may be a function of bleeding volume. By way of example and not limitation, the RS may be defined as (BRₐ−BR₀)/BR₀ or (BRₐ−BR₀)/BRₐ where the dermal bleeding rate BR=BV/BT, BV is dermal bleeding volume, BT=bleeding time, BRₐ is bleeding rate with aspirin or blood thinning medication and BR₀ is bleeding rate without aspirin or blood thinning medication. The RS may alternatively be defined as (BVₐ−BV₀)/BV₀ or (BVₐ−BV₀)/BVₐ where BVₐ is bleeding volume with aspirin or blood thinning medication and BV₀ is bleeding volume without aspirin or blood thinning medication. As a further alternative to the resistance score, the same may be expressed as a difference in BVₐ−BV₀ where BVₐ is bleeding volume with aspirin or blood thinning medication and BV₀ is bleeding volume without aspirin or blood thinning medication. As a further alternative to the RS, the same may be expressed as an abstract number or concept. By way of example and not limitation, the RS may be expressed as average blood thinning medication resistance, highly resistant to blood thinning medication or low resistance to blood thinning medication. Also, the RS may be expressed as a number from one (1) to ten (10) wherein one (1) through three (3) represents low resistance to blood thinning medication, a number between four (4) through seven (7) represents an average resistance to blood thinning medication and a number between eight (8) through ten (10) represents highly resistant to blood thinning medication. The medical professional may use this RS value to made an educated treatment decision for a particular patient 10.

As shown above, the RS may be defined as a unitless number such as (BRₐ−BR₀)/BR₀ or (BVₐ−BV₀)/BV₀. These RS are unitless numbers. By way of example and not limitation, the formula (BVₐ−BV₀)/BV₀ can also be expressed as the number of pixels forming the blotches 28 for the second set of blotter paper 14 minus the number of pixels forming the blotches 28 for the first set of blotter paper 14, the result of which is divided by the number of pixels forming the blotches 28 in the first set of blotter paper 14. The same pixel based calculation can be done for (BRₐ−BR₀)/BR₀ or (BRₐ−BR₀)/BRₐ or (BVₐ−BV₀)/BVₐ.

In the event that the medical professional does not have a line of communication (e.g., fax line, email, internet, etc.) to a service provider 20, the medial professional may download and/or install a bleeding volume application (i.e., computer software, program, etc.) onto a local computer where the medical professional is located. By way of example and not limitation, the local computer may be a smart phone, net book, laptop, desk top, hand-held electronic device, hand-held camera, internet enabled camera, etc. Alternatively, the medical professional may obtain or purchase a dedicated computer unit (e.g., handheld computer, laptop, desk top, etc.) that includes one or more features of the bleeding volume application.

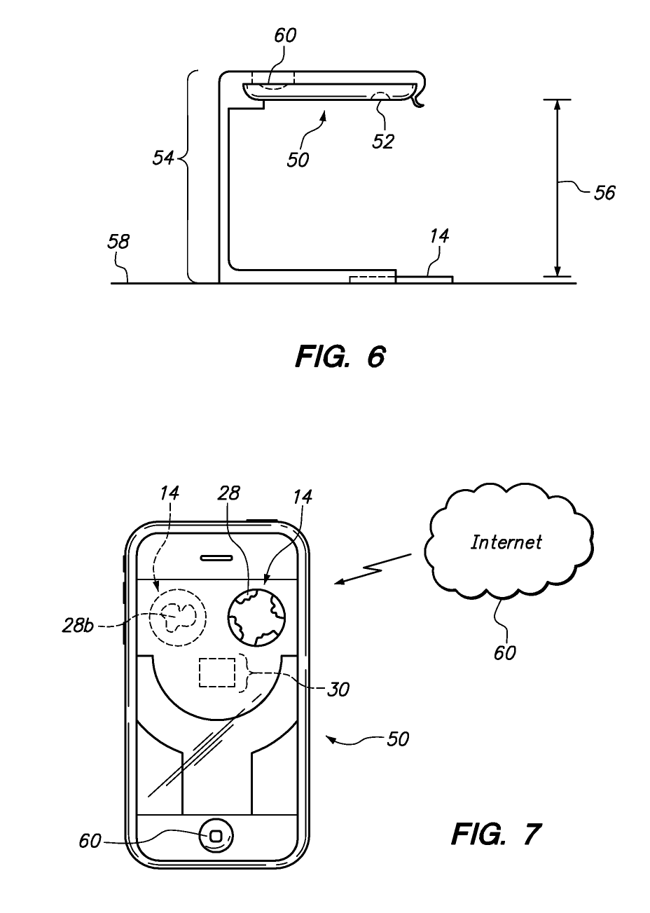

Referring now to FIGS. 6 and 7, by way of example and not limitation, the computer may be a phone 50 (e.g., iPhone, Blackberry, etc.). The phone 50 may have a camera 52 integrated into the phone 50. Additionally, the phone 50 may have a microprocessor and memory for downloading bleeding volume application and running the bleeding volume application directly from the phone 50. The computer application may include and is not limited to the bleeding volume application. The phone 50 may take a photograph of the blotter paper 14 with blotches 28 of blood thereon for the purposes of determining a value associated with the bleeding volume or value associated with the difference in bleeding volume before and after a patient ingests a drug or blood thinning medication. In order to properly calculate a value associated with the surface area of the blotch 28 formed on the blotter paper 14, the phone 50 may be mounted to a stand 54 that places the camera 52 of the phone 50 a set distance 56 away from the blotter paper 14. In particular, the stand 54 may orient the phone 50 in a horizontal direction so that the camera provides a top view of a support surface 58. Preferably, the blotter paper 14 is disposed centrally to the camera and flat upon the support surface 58 to minimize distortion of the blotch of blood 28 on the blotter paper 14. FIG. 7 illustrates a photograph of the blotter paper 14 with blotch 28 of blood thereon. Since the camera 52 of the phone 50 is a known distance away from the blotter paper 14, a conversion ratio for number of pixels to surface area of blotch 28 of blood may be calculated or empirically determined.

Referring now to FIG. 7, the photograph taken by the camera 52 of the phone 50 may capture the blotches 28 formed on the blotter paper 14. Additionally, the bleeding volume application for determining the value associated with bleeding volume or difference in bleeding volume may be installed onto the phone 50. By way of example and not limitation, the phone may download the bleeding volume application by way of the internet 60, wirelessly, through a cable connection, compact disc or memory device. Once the photograph of the blotter paper 14 is taken by the camera 52 of the phone 50, the bleeding volume application may automatically determine the outline and surface area or pixels of the blotches 28 and calculate the value associated with the bleeding volume. Preferably, the blotter paper 14 is placed on a white background. The bleeding volume application may also determine the resistance score (RS) by leading the user to identify the various sets of blotter papers 14. The bleeding volume application may automatically calculate the surface area of the blotch 28 formed on the blotter paper 14 of the various sets. Additionally, the bleeding volume application may determine the value associated with the difference in bleeding volume before and after administration of blood thinning medication to the patient. It is also contemplated that the bleeding volume application may enable the user to hand trace the blotch 28 of blood on the blotter paper 14 instead of automatically recognizing the outline of the blotch 28.

In lieu of the camera stand 54, the blotter paper 14 may be photographed alongside a reference area 30 or reference blotch 28b formed on a blotter paper 14. The reference area 30 or the reference blotch 28b may be disposed at the same plane as the blotter paper 14 having the patient's blotch of blood 28 (see solid lines in FIG. 7). The bleeding volume application may automatically recognize or manually recognize by user input the reference blotch 28b or reference area 30 to determine the value associated with the bleeding volume on the blotter paper 14 represented by the blotch 28 of blood. Alternatively, the bleeding volume application may allow the user to trace the reference blotch 28b or the reference area 30. As a further alternative, a square reference area may be formed on the blotter paper 14 to account for any angled shots of the blotter paper 14 by the camera. If the square appears to be trapezoidal on the photograph, then the computer application may account for the angle through an algorithm.

After taking the photograph with the camera, the bleeding volume application may provide the back end calculation in order to empirically determine the value associated with the bleeding volume of the patient or the value associated with the difference in bleeding volume before and after ingestion of blood thinning medication by the patient. If a communication link (e.g., internet, land line, etc.) can be established with the service provider 20, then the value associated with the bleeding volume of the patient or the value associated with a difference in bleeding volume before and after ingestion of the blood thinning medication by the patient 10 may be calculated or determined by the back end server. Also, such values may be compared with a broader current statistical sample based on age, race, gender, etc. which may be stored on the service provider's server and updated through continued use of the method and system described herein by other medical professionals. Other medical professionals may allow the service provider's server to store and share such data of other patients without identifying the patient with other medical professionals. If the communication link cannot be established with the service provider 20, then the value associated with the bleeding volume of the patient or the value associated with the difference in bleeding volume before and after ingestion of the blood thinning medication by the patient may be compared to the sample available at the time the bleeding volume application was downloaded or installed to the phone 50.

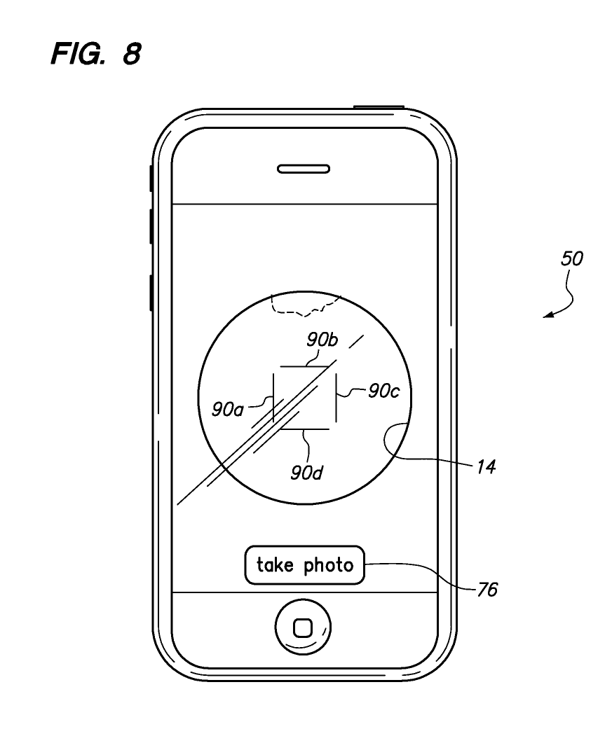

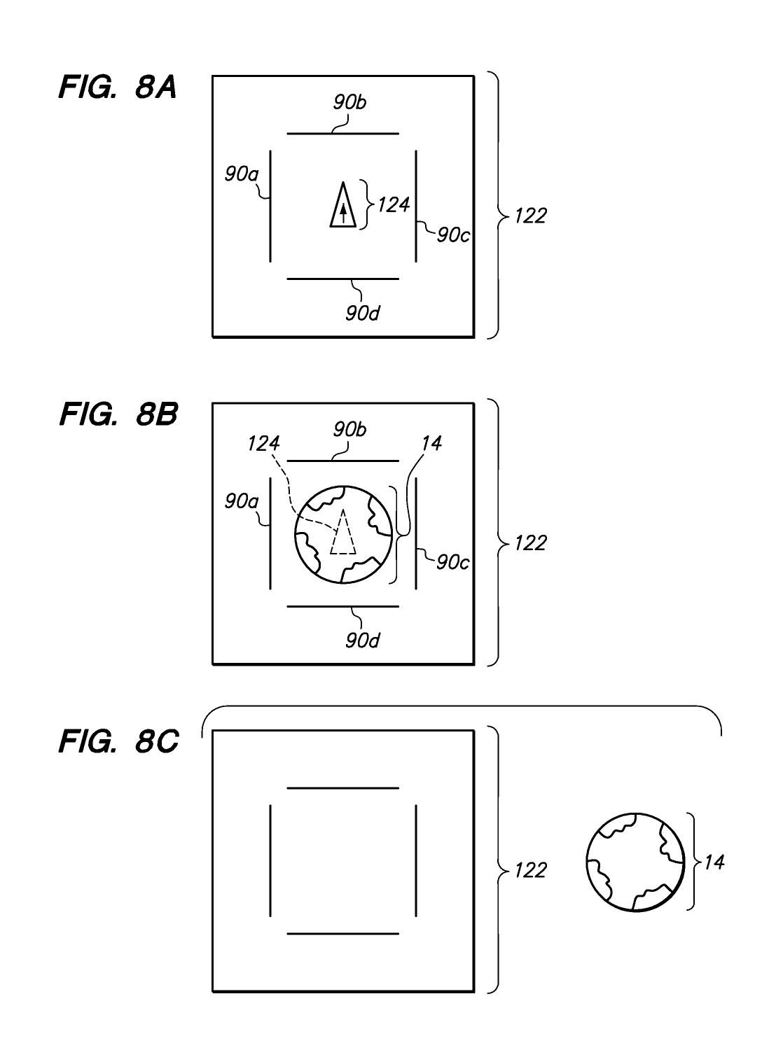

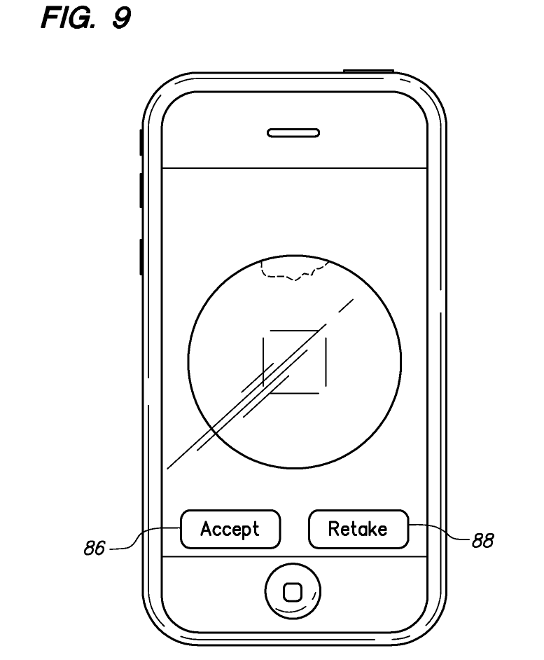

Referring now to FIG. 8, a smart phone 50 is shown. The bleeding volume application for determining the value associated with a bleeding volume or difference in bleeding volume may be installed on the phone 50. Upon start up of the bleeding volume application, the user may identify whether a screening IVPFT or post-drug IVPFT is desired. (hereinafter IVPFT refers to in-vivo platelet function test). For each of the screening IVPFT and post-drug IVPFT, the user may select a single set or double set. When double set is selected, the results may be averaged for a smaller variance. In the single set screening IVPFT, only one test is performed on one forearm of the patient. In double set, one test may be performed on the left forearm of the patient 10. Also, a second test may be performed on the right arm of the patient 10. Results may be averaged for comparative analysis purposes. After the screening IVPFT or post-drug IVPFT and the single or double set options are selected, the bleeding volume application may request entry of the generic name of the drug for the purposes of the post-drug IVPFT test. There may be a dropdown menu which can be loaded from the back end server side or the list may be resident in the bleeding volume application. For a single screening IVPFT test, the bleeding volume application may request the user to take photos of one or more bloody discs. For double screening IVPFT tests, the computer application may request the user to take photos of the bloody discs for a first set and a second set. For single set post-drug IVPFT tests, the computer application may request the user to take photos of control or pre-drug bloody discs. Also, the bleeding volume application may request the user to take photos of post-drug bloody discs. For double set post-drug tests, the bleeding volume application may request the user to take photos of a first set of a control/pre-drug bloody disc. Also, the bleeding volume application may request the user to take photos of a second set of control/pre-drug bloody disc. The bleeding volume application may also request the user to take photos of first and second sets of post-drug bloody discs.

In order to properly take the photo of the bloody disc, the blotter paper 14 may be provided with four lines 90a, b, c, d, as shown in FIG. 8. The four lines 90a-d may be oriented 90° to each other so as to form a square. The four lines 90a-d may be disconnected as shown in FIG. 8A or connected end to end. Alternatively, the four lines 90a-d may be printed on a separate paper 122, as shown in FIG. 8A. The blotter paper 14 may be laid within the four lines 90a-d provided that the blotter paper 14 can fit within the four lines 90a-d (see FIG. 8B) or may be laid adjacent to the four lines 90a-d (see FIG. 8C). The blotter paper 14 and the separate paper 122 can be digitally captured in either configuration (FIG. 8A or 8B). If the blotter paper 14 is laid within the four lines 90a-d as shown in FIG. 8B, the first blotch of blood may be aligned to the arrow 124. The four lines 90a-d provide a known standard by which the blotches of blood on the blotter paper 14 can be adjusted. The four lines 90a-d may be a known length such as 128 mm each. The bleeding volume application can use the known length of the lines 90a-d and the imaged length of the lines 90a-d to determine the surface area of the blotches of blood on the blotter paper. Also, the four lines can be used to fix any misalignment when digitally capturing the blotter paper 14 with blotches of blood. The four lines 90a-d configured as a square are provided as an example and not limitation. Other configurations are also contemplated such as triangular, parallelogram. As long as the angles and lengths of the lines that make up the alternate configuration are known the bleeding volume application can use the known standard and the imaged version of the known standard to arrive at the surface area of the blotches of blood. Furthermore, instead of lines, the known standard may be a known surface area such as a pre printed circle or square. The number of pixels contained within the known standard can be used to derive a pixels per surface area conversion ratio that can be used to derive the surface area of the blotches of blood.

Upon viewing the blotter paper 14 (and the four lines 90a-d) within the viewable area of an image capture device (e.g., smartphone with digital camera, digital camera, etc.) in this instance the camera of a phone, the user may press the “take photo” button 76. After taking the photo, the user may be given a choice to accept 86 the taken photo or to retake 88 the photo (see FIG. 8). Once all of the bloody discs are photographed and identified as a single screening set, first or second set for the double screening set, control or post-drug bloody disc for a single set post-drug test, first or second set of a controlled or post-drug bloody disc for a double set post-drug test, the bleeding volume application may identify each bloody disc as belonging to a particular set or group. The phone 50 may provide backend calculation support to determine a value associated with the bleeding volume of the patient or a value associated with a difference in bleeding volume before and after ingestion of a blood thinning drug. Alternatively, the phone 50 can transmit the photos to the backend server for processing. It is contemplated that the phone 50, backend server either alone or in combination with each other may perform the calculations and functions to derive the bleeding volume based value or value associated with a difference in bleeding volume.

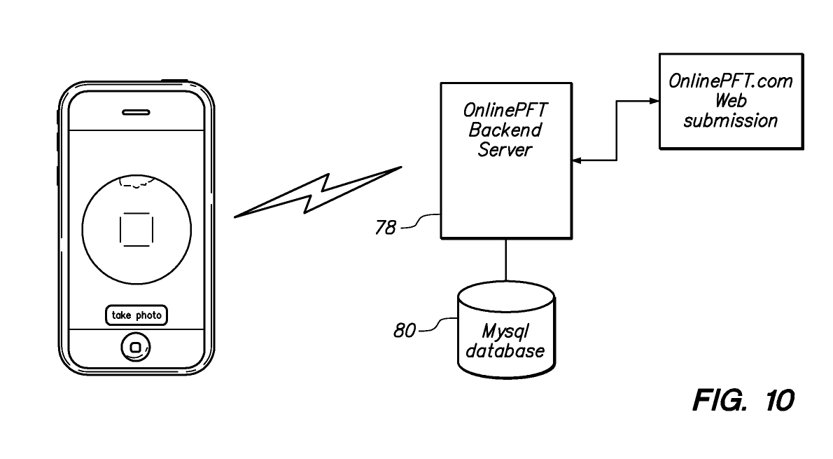

The photographed bloody disc may also be transmitted to a backend server 78 as shown in FIG. 10 if a communication link can be established between the backend server 78 and the phone 50. The backend server 78 and database 80 may provide backend calculation, diagnostic analysis, archival storage of data for analysis, statistical analysis and other useful functions such as user accounts (e.g., usernames, passwords, contact information, payment information). Also, the backend server 78 and database 80 may provide billing information and serve up e-mail responses to the user. The backend server 78 may send a text message, e-mail or other communication to the user indicating that processing of the disc has been accomplished or finished. The user may receive an e-mail which includes the test results or instruction on how to retrieve the results from a website. The user may log on to a website to retrieve the diagnostic results. In lieu of or in conjunction with the smart phone 50, the website may also provide registration function. Also, the website may provide a web based submission form with a collection or download process of the discs in lieu of or in conjunction with the smart phone 50.

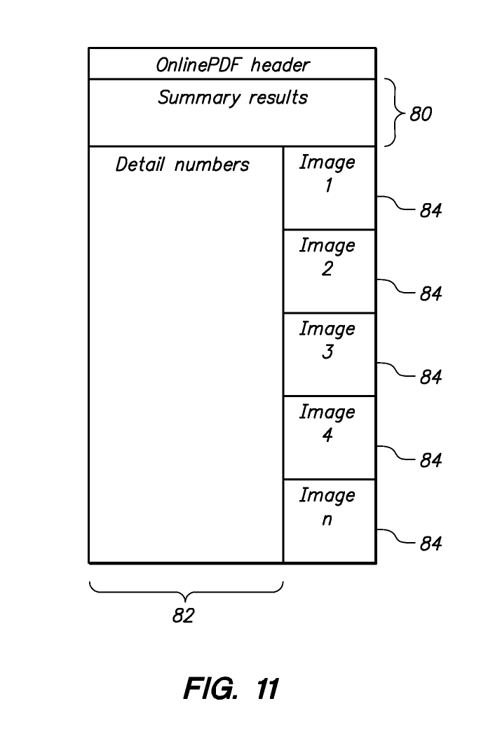

Referring now to FIG. 11, the results may be transmitted to the medical professional such as by way of pdf, email, fax, voice mail, etc. By way of example and not limitation, the PDF may have a summary of results section 80. Additionally, detailed numbers of the photographed discs 82 may be provided. Individual images 84 of the disc may also be provided. Each image may be labeled 1-N, in the order submitted. If there are multiple sets, then each set may have a title identifying the set (such as “Set 1”, “Set 2”, etc). The log files in the server may store all information including the images except for a patient ID which may be replaced with a sequential number. This means that the patient ID is only known by the doctor. The server may store only the time stamp for the entry and the doctor name. In this manner, the doctor will be able to match the results with the patient if need be. It is also contemplated that the results may be emailed to the medical professional's phone 50, medical professional's email and/or stored in the patient's electronic medical record (“EMR”).

Within certain limits, for any small microliter volume V of blood absorbed onto a standardized blotter paper there is a one-to-one correspondence between V and the resulting surface area of the blood stain on the blotter paper. Just as there is no statistically intrinsic difference between measuring a distance in millimeters or centimeters, within certain limits there is no intrinsic difference between the amount of bleeding measured in mm² (Bleeding Area) or mm³(Bleeding Volume). Thus the Bleeding Area A and the Bleeding Volume V can be considered statistically equivalent. Define Alpha (α) to be the ratio V/A=α so that given area A, the volume V can be determined by the equation V=αA. From a statistical perspective, A and V can be estimated from a plurality of blood stained blotter papers as the means (or averages) of individual measurements Ai and Vi, for all i, where i=1, 2, . . . , n.

The bleeding area of the blotches of blood which stain the blotter paper 14 may be calculated. The bleeding area may be the total area of blood stains accumulated on the blotter paper during a bleeding time test. The server and/or bleeding volume application may count the number of pixels of the blotches of blood on the bloody disc. Before doing so, the bleeding volume application may properly align the image of the bloody disc to properly measure the number of pixels per surface area. In particular, the four lines 90a-d of known length may be imprinted on the blotter paper. The four lines 90a-d may be formed so as to be orthogonal to each other and form a square. If the image of the lines 90a-d are not orthogonal, then it means that the blotter paper 14 was taken at an angle and not straight on (i.e., perpendicular) to the blotter paper 14. In other words, the line of sight of the camera's lens was not directly perpendicular to the blotter paper 14. In this instance, the lines 90a, c or 90b, d will appear to be skewed with respect to each other instead of parallel since photos are taken in a diminishing perspective view. Also, the adjacent lines 90a, b or 90b, c or 90c, d or 90d, a would not be perpendicular with respect to each other. If the four lines 90a-d are not at the same distance to the eye of the camera, then the four lines 90a-d will be skewed and not orthogonal to each other. The four lines 90a-d will not look like a square. The bleeding volume application has a transformation function which realigns the image of the blotter paper 14 based upon the four lines 90a-d. The bleeding volume application calculates the misalignment in the lines 90a-d and transforms the entire image so that the four lines 90a-d forms a square shape. After the digital image undergoes the transformation function, the bleeding volume application may count the number of pixels of blotches of blood on the bloody disc.

The transformation function readjusts the image of the known standard (e.g., square, triangle, etc.) to what the known standard should actually look like so that the image of the known standard is not skewed due to the diminishing perspective of a camera. In particular, the four lines would be 90 degrees with respect to adjacent lines. Other shapes are contemplated for the known standard. For example, if the known standard is changed from the square to an equilateral triangle, the transformation function would readjust the image of the triangle so that each of the three angles are equal to each other. If the known standard was changed from the square to a parallelogram of known angular relationship, then likewise, the transformation function would readjust the image of the parallelogram so that lines of the imaged parallelogram would be at the known angular relationships. In doing this transformation function, the bleeding volume application knows how to transform the blotches of blood on the blotter paper since the amount of skewing of the blotches of blood on the blotter paper is the same as the amount of skewing of the known standard. The adjustment performed on the imaged standard can also be performed on the blotches of blood to the same degree to account for the diminishing perspective or misalignment.

After the transformation function, the bleeding volume application counts the number of pixels in each of the lines 90a-d. The number of pixels are then summed up and divided by the total length of the lines 90a-d. The lines 90a-d may be of a known length so that dividing the number of pixels by the known length will provide the pixels per linear length. With this information, the surface area of the blotches of blood may be calculated. In particular, the pixels per linear length will squared to arrive at a pixels per area or conversion ratio. For example, if there are 100 pixels per inch then squaring this number will provide a conversion ratio of 1000 pixels per square inch. The number of pixels of the blotches of blood is divided by the conversion ratio to arrive at a surface area.

Other methods for determining the surface area, expressed in either square millimeters (mm²) or square centimeters (cm²), of the blood stains on a piece of blotter paper are also contemplated which may be incorporated into the methods and apparatus described herein.

By way of example and not limitation, in a method, on a piece of blotter paper of arbitrary dimensions, print a black square having 10 mm sides and thus a surface area of 100 mm². Collect blood stains on the edges of the blotter paper and then make a digital photo image of the blood stained blotter paper. 1) Count the total number of pixels (P_{B}) in the blood stains; 2) Count the number of pixels in the standard 10 mm×10 mm black square (P_{S}); 3) Conclude that the surface area of the blood stains is (P_{B}/P_{S})mm². This method has the logistical disadvantage of having to print a black square on a piece of blotter paper, physically transport the printed blotter paper to clinician before the blotter paper can be used to measure the surface area of a set of blood stains.

Another method of measuring the surface area of blood stains on a piece of blotter paper involves determining the number of pixels within the image of a blotter paper having a standard shape and dimension. For example, consider a round disc-shaped blotter paper having a known radius R=55 mm and surface area A=πR². A method for determining the total surface area of the blood stains on this piece of blotter paper is as follows: 1) Make a digital photo image of the blood stained blotter paper disc; 2A) Count the number of pixels P_{A} within the digital image of the entire disc including blood stained and non-stained paper; 2B) Alternatively, assuming that the digital image of the disc is actually an ellipsoid rather than a perfect circle, count the number of pixels along multiple diameters; Let D_{P}=the diameter having the maximum number of pixels among all measured diameters; let |D_{P}|=the number of pixels along D_{P}; let R_{P}=|D_{P}|/2; d_{P}=the number of pixels along the diameter perpendicular to D_{P}, and rp=d_{P}/2 and using the standard formula for the area of an ellipsoid having major and minor axes, the area of the ellipsoid is P_{A}=π[(R_{P}+r_{P})/2]²; 3) Determine the known true surface area of the blotter paper A=πR² in terms of mm²; 4) Calculate the standard number of pixels per mm² within the photo image of the disc=P_{A}/A=P_{S}; 5) Count the total number of pixels (P_{B}) in the image of the blood stains; 6) Conclude that the surface area of the blood stains is (P_{B}/P_{S})mm²

In another alternative method of measuring the surface area of blood stains on a piece of blotter paper, the method involves determining the number of pixels within the image of a white square having sides of length S defined by peripheral black lines having width w (for example w may equal 1 mm, and S may equal 130 mm or equivalently, if the resolution of the digital image is known then S can be expressed in terms of pixels per mm). A method for determining the total surface area of the blood stains on this piece of blotter paper is as follows: 1) Download and print a PDF document from some designated website, for example www.onlinePFT.com, such that the PDF document shows a white square with sides of length S and surface area S², delineated by peripheral black line having width w. 2) Place the page with the printed square facing up on a flat surface. 3) Place the blood stained blotter paper disc within the white square and not overlying the black peripheral lines. 4) Make a digital photo image of the blood stained blotter paper disc lying within the white square. 5) Count the number of pixels P_{A} within the digital image of the white square, where this image may not be a perfect square but rather may appear as a “nearly-square quadrilateral” due to the foreshortening which occurs whenever the camera is not aimed perfectly along a line perpendicular to the center of the printed square. 6) Express the surface area of S² in terms of the expected number of pixels per unit area. Let P_{S}=P_{A}/S². 7) Count the total number of pixels (P_{B}) in the image of the blood stains. 8) Conclude that the surface area of the blood stains is (P_{B}/P_{S})mm².

All of these methods are independent of the resolution of the digital camera employed in making a digital photographic image of both the blood stained disc and the reference geometric shape (for example square, circle or square).

Alpha may vary from patient to patient as a function of hematocrit (e.g., packed cell volume), mean corpusculor volume (MCV) of red blood cells, or red blood cell sedimentation rate (sed rate). Alpha may represent the mean of all alphas among a set of a statistically relevant statistical group of patients.

A platelet function score aspirin-effect or PFₐₛₐ may be represented as (BVₐₛₐ−BV₀)/BV₀=(BAₐₛₐ−BA₀)/BA₀ wherein BVₐₛₐ, BAₐₛₐ, BV₀ and BA₀ are the bleeding volume and bleeding area with and without the aspirin (ASA), respectively. The above definition of PFₐₛₐ has two aspects. First, PFₐₛₐ is independent of the value of alpha. As such, the PFₐₛₐ can be calculated either using BV or BA without reference to alpha. Second, PFₐₛₐ is a continuous variable as contrasted to a dichotomous or yes-no variable. Aspirin resistant score expressed in terms of a continuous variable provides a means of quantitatively describing degrees of aspirin resistance.

The same definition can also be used when studying the in-vivo effect on other platelet-active drugs such as clopidogrel, pentoxifylline, and dipyridamole. By way of example and not limitation, if a study of effect of a drug D on platelet function is being conducted, then the effect of drug D on platelet function PF_{D} may be defined as PF_{D}=(BV_{D}−BV₀)/BV₀ which is also equal to (BA_{D}−BA₀)/BA₀ wherein BV_{D}, BA_{D}, BV₀ and BA₀ are the bleeding volume and bleeding area with and without the drug D, respectively. The PF_{D} is independent with respect to alpha (i.e., PF_{DE} is not dependent on the value of alpha).

The following may be useful Drug Resistance Scores (DRS). By way of example and not limitation, in the case of aspirin resistance, DRS_{A} may represent the Drug Resistance Scores for aspirin. DRS_{A} may be calculated for Bleeding Time (BT), Bleeding Area (BA) and Bleeding Rate (BR) where BR=BA/BT, in other words, the total bleeding volume that oozes out of the tiny incision during a bleeding time test divided by the duration of the bleeding time. Thus, DRS_{A}(BT)=(BT_{A}−BT₀)/BT₀ where BT₀ is the control bleeding time obtained when the patient has not taken any platelet active drugs for a significant period of time (e.g., more than a week), and BT_{A} is the bleeding time obtained after a significant period of time (e.g., one hour) has elapsed since the patient has taken a blood thinning medication (e.g., 81 mg of aspirin). Similarly one can define DRS_{A}(BA)=(BA_{A}−BA₀)/BA₀ and DRS_{A}(BR)=(BR_{A}−BR₀)/BR₀

In another method of calculating a value associated with the bleeding volume or difference in bleeding volume before and after ingestion of a blood thinning medication, it is contemplated that the pixels per surface area of the entire blotter paper 14 may be used to calculate the value associated with the bleeding volume or difference in bleeding volume before and after ingestion of a blood thinning medication. In particular, a standard Whatman #1 blotter paper may be used which has a known surface area. The Whatman #1 blotter paper 14 is circular and has a known radius R=55 mm. The surface area of the Whatman #1 blotter paper 14 is calculated by the formula πR². The number of pixels for the entire Whatman #1 blotter paper 14 that has been photographed may be determined by the bleeding volume application. The pixel count of the photographed blotter paper 14 and the known surface area of the Whatman #1 blotter paper is used to calculate a conversion ratio of pixels per surface area. Next, the number of pixels of the photographed blotches of blood on the blotter paper 14 is determined by the bleeding volume application. The pixel count of the blotches of blood on the blotter paper 14 is divided by the conversion ratio of pixels per surface area to derive the actual surface area of the blotches of blood on the blotter paper. For each photographed blotter paper, a new conversion ratio may be determined. Alternatively, one conversion factor may be used for one or more of the sets of photographed blotter paper.

Once the actual surface area of the blotches of blood on the blotter paper is determined, the actual surface area may be correlated to a value associated with the bleeding volume or difference in bleeding volume before and after the ingestion of a blood thinning medication. Additionally, the actual surface area may be multiplied by the alpha a ratio discussed above to arrive at a bleeding volume.

In relation to conducting the test described herein, the incision in the patient's forearm may be a horizontal incision. However, vertical incisions may also be made. Regardless of whether a horizontal or vertical incision is made, the same type of incision should be conducted throughout the tests. By way of example and not limitation, if the statistically relevant group is tested with a horizontal incision, then the patient should be tested with a horizontal incision, and likewise for a vertical incision. Moreover, the incision may typically be located on the lateral aspect of the volar forearm approximately 5-10 cm below the antecubital crease. The depths of the incision may be 1 mm or just deep enough to transact capillary loops and the smallest vessels but superficial to most pain fibers. Preferably, the skin temperature may be regulated.

When absorbing the blood, the blotter paper 14 should be held at an angle that does not rest flat against the patient's skin. If the bleeding time exceeds fifteen minutes, then the procedure should be discontinued and pressure applied to the wound site. The test should be repeated on the other arm. If the bleeding time again exceeds fifteen minutes, then either the patient has a bleeding disorder or the incision device randomly cut a larger than average blood vessel in the skin. If the bleeding has not again ceased within fifteen minutes, then the results are reported as greater than fifteen minutes.

By utilizing the bleeding volume application, it is also contemplated that the bleeding area for each blotch of blood may be determined. Other available quantitative results include 1) BA (BV) which is bleeding area (bleeding volume), 2) Aᵢ (Vᵢ) which is bleeding area (volume) during the i^{th} 30 second time interval, I=1, N, 3) CAi (CVi) which is cumulative bleeding area (volume) as a function of the i^{th} 30 second time interval, 4) BT which is bleeding time, 5) BR_{A}=BA/BT which is Total bleeding rate (area/time), 6) ΔAᵤ=Aᵢ₊₁−Aᵢ which is incremental bleeding rate (area) as a function of the i^{th} 30 second time interval, 7) BRᵥ=BV/BT which is total bleeding rate (volume/time), 8) ΔVᵢ=Vᵢ₊₁−Vᵢ which is incremental bleeding rate (volume) as a function of the i^{th} 30 second time interval, 9) MaxAᵢ (MaxVᵢ) which is largest Aᵢ (Vᵢ), for all i=1, N, 10) Tₘₐₓ which is duration of time until MaxAᵢ (MaxVᵢ) occurs and 11) Tₘₐₓ/BT which is relative Tₘₐₓ=the duration until Tₘₐₓ occurs relative to BT wherein N is the number of blood stains on the blotter paper. Other quantifiers are also contemplated.

The bleeding volume test described herein may be used (1) to aid a researcher investigating the pharmacologic effects of drugs on platelet function drugs including but not limited to aspirin, clopidogrel, lidocaine and statins (HMG-CoA reductase inhibitors) (2) for pre-surgical assessment of a patient's risk for excessive surgical bleeding, (3) for routine clinical assessment of the effectiveness of thrombo-prophylaxis by aspirin or clopidogrel or other antiplatelet drug including but not limited to testing for aspirin resistance, and (4) to aid clinicians seeking a simple inexpensive in-vivo screening test for diseases of abnormal platelet function such as von Willebrand disease (vWD).

It is also contemplated that the bloody discs may be submitted to the backend server by way of a desktop. The first step may include the step of downloading instructions. Using an electronic scanner (e.g., a digital scanner), a single image file or document (e.g., jpeg) of the bloody discs with a white background (e.g., white paper) may be made. The jpeg image may be saved to the computer hard drive. Preferably, the image resolution of the jpeg file may be 72 pixels/inch (28.346 pixels/cm) and the height and width of the document may be 5.5 inches (400 pixels)≦height≦12.5 inches (900 pixels) and 4.2 inches (300 pixels)≦width ≦9.7 inches (700 pixels).

Next, the data entry form on a website linked to the backend server may be filled out. This may include a) medical professional's Email (User ID) and Password which may be entered upon Login to the website; b) Patient's Name or some ID# (chosen by the medical professional); c) Assign Number(s) to bloody Control Disc (e.g. C1, C2, . . . ) and Date & Time of Control Disc; d) Assign Numbers to bloody Test Disc (e.g. T1, T2, T3, . . . ) and Date & Time of Test Disc; e) Provide generic name(s) of test-drug(s) and Date & Time Test Drug Delivery into patient; f) List of Drugs Taken by Patient within past 7 days; g) Known Lab values, if available, including: Platelet Count, Hematocrit (Packed Cell Volume), Skin Temperature (° C.), serum creatinine; h) Patient's Diagnoses: Known, Suspected, Associated; i) List of Email(s) to Receive IVPFT Results and j) Patient's Insurance Information.

After filling out the data entry form, the jpeg images of the bloody discs may be uploaded to the website linked to the back end server. The user may browse through the jpeg images to recheck quality of the images, then click “send”.

The bleeding volume application, the backend server or combination thereof may count the number of pixels of the image of the blood stains on the bloody disc. Also, the surface area of the blotches of blood on the bloody discs may be calculated as discussed herein.

The backend server may return the following results of the in-vivo PFT measurements by email and send duplicate information directly to the patient's electronic medical record file. The results include but is not limited to a digital photo image of the uploaded jpeg documents (convenient for medical records) together with the following information imprinted on the page; Bleeding Time (BT) and (Range of Normal); Bleeding Area=BA=ΣAi, for i=0, . . . , N the total area of all blood stains Ai, and (Range of Normal); Bleeding Rate (BR)=BA/BT, and (Range of Normal); Ai=Area of i^{th} blood stain on PFT-Disc; Bleeding Area Cumulative BAC(n)=ΣAi, for i=0, . . . , n where n≦N; Differential Bleeding Area={Ai−Ai−1, . . . , N}=dA/dt=rate of change of Ai; maxAi=largest of all Ai Also (i/N)ε(0,1) which indicates the fractional interval of the bleeding time when maxAi occurs; and max (Ai−Ai−1) maximum rate of increase of the Ai; min (Ai−Ai−1) maximum rate of decrease of Ai; and Bleeding Volume Estimated (BV_{E})=αBAT, & (Range of Normal) where α is the population estimate of the proportionality constant α.

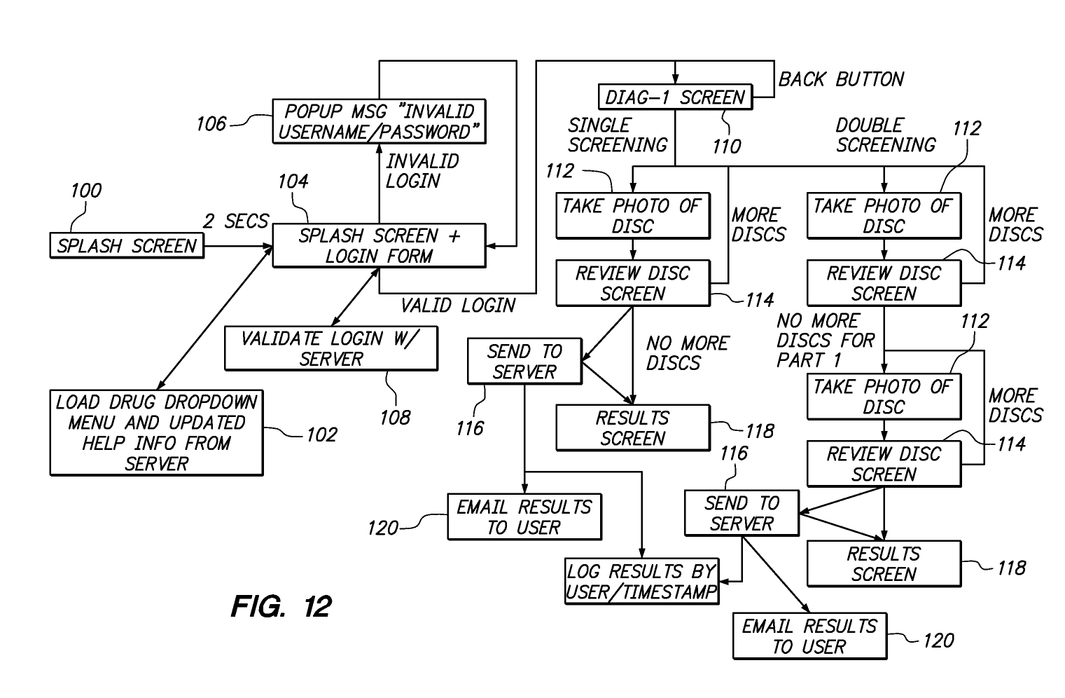

Referring now to FIG. 12, a flow chart for the bleeding volume application is shown. Initially, when the user brings up the bleeding volume application on the user's phone 50 or when the user goes to a bleeding volume test website (e.g., www.onlinepft.com), the user may be presented with a splash screen 100. If the communication link is established between the phone 50 or computer processor and the backend server 78, a list of drugs may be loaded to the bleeding volume application which contains an updated list of potential drugs 102 for screening and/or pre/post drug testing. The user is presented with a splash screen 100 and login form 104 in which the user must provide the appropriate username/password combination; otherwise, the user will be presented with an invalid username/password warning 106. When the appropriate username and password are supplied in the login form 104, the back end server 78 and/or the bleeding volume application may validate 108 and move the user to a first diagnostic screen 110 in which the user must select a single screening or double screening option. Upon selection of the single screening option, the bleeding volume application instructs the user to take photos of a disc 112 and review those discs 114. The user continues to take photos 112 and review the photographed disc 114 until there are no more discs to photograph. If the phone 50 or computer has a communication link to the back end server 78, then the photographed discs are sent to a server 116 which performs the backend calculation to provide a value associated with bleeding volume or a value associated with difference in bleeding volume based on pre and post drug conditions. The results may be sent to the computer and show up on a results screen 18 and/or the results may be emailed 120. The backend server 78 may store the results by username and time stamp. If no communication link is established with the backend server 78, then the bleeding volume application may provide the backend calculations for determining a value associated with bleeding volume or value associated with difference in bleeding volume based on pre and post drug conditions. The results are sent immediately to the results screen 118.

If the double screening option is selected, then the user takes photos 112 and reviews 114 those photos which are part of a first set. When all of the discs for the first set are photographed, then the bleeding volume application leads the user to take photos and review those photos 112, 114 of a second set. Similar to the single screening option, the photographed discs may be sent to a server 116 with results sent to a results screen 118 of the phone 50. Also, the backend server 78 may send results 118 to the user by way of email 120. If no communication link is established with the backend server 78, then the bleeding volume application may send the results only to the results screen 118.

It is also contemplated that the user may be presented with a second diagnostic screen which allows the user to select a screening test or a pre/post drug test. If the screening test is selected, then the above mentioned steps and the flow chart shown in FIG. 12 are followed. If the pre/post drug test is selected, then the above steps are supplemented with an additional set of bloody discs representing the control set and the drug set.

The bleeding volume application as discussed herein with respect to a portable phone 50. However, it is also contemplated that the bleeding volume application may be uploaded and installed onto a desktop computer. The bloody discs may be uploaded to the computer by way of the computer's camera. Alternatively, the user may take photos of the one or more bloody discs and upload the photographs to the computer for processing by the bleeding volume application or transmission to the backend server 78 for further calculation and processing as discussed above.

The above description is given by way of example, and not limitation. Given the above disclosure, one skilled in the art could devise variations that are within the scope and spirit of the invention disclosed herein. The method and apparatus described herein was described in relation to measuring blood. However, other types of fluids, gas and fine particulate can be measured utilizing the method and apparatus described herein. The measuring technique described herein can be utilized to measure small volumes of liquid or gas or measure a small mass of powder by photographically measuring an associated pigmented surface area which develops upon the specialized blotter paper. A blotter paper specifically treated with an appropriate chemical may change color when the paper comes into contact with a specified liquid; for example the measuring technique described herein can be used to quantitatively measure minute volumes of rain falling on a specialized piece of blotter paper such that the blotter paper changes color wherever rainwater contacts the paper and where the area of changed color on the blotter paper is proportional to the volume of rainwater. Similarly a small volume of gas leaking out of a container can be quantitatively measured when the gas comes into contact with a specialized blotter and causes the blotter paper to change color in proportion to the volume and density of gas coming into contact with the paper. Analogously, using a digital photographic analysis technique similar to the bleeding volume test, a minute mass of a powder may be quantitatively measured when the powder comes into to contact with a chemically treated or moistened blotter paper and causes the blotter paper to change color in proportion to the mass of powder contacting the paper. To carry this analogy one step further, the digital photographic technique of the bleeding volume test or the measuring technique described herein can be used to photograph and quantitatively measure the quantity (mass) of a minute amount of protein or nucleic acid collected during the process of gel electrophoresis; in this application instead of merely counting the number of pixels within a certain digital image, the computer program can quantitatively account for the number and density of specifically colored pixels within a digital image. Furthermore, just as with the bleeding volume test, all of the examples described above in this paragraph can be analyzed with either a relatively expensive cumbersome personal computer in conjunction with a digital scanner or with a relatively mobile and inexpensive 3G cellular telephone capable of taking and transmitting a digital photograph.

The above description is given by way of example, and not limitation. Given the above disclosure, one skilled in the art could devise variations that are within the scope and spirit of the invention disclosed herein, including various ways of transmitting the scanned images. Further, the various features of the embodiments disclosed herein can be used alone, or in varying combinations with each other and are not intended to be limited to the specific combination described herein. Thus, the scope of the claims is not to be limited by the illustrated embodiments.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A method of processing a standard sized blotter paper with blotches of blood to derive a value indicative of a bleeding volume of a person, the method comprising the steps of:
electronically imaging a single two dimensional view of the blotches of blood formed on a first blotter paper;
determining a pixel to surface area ratio based on a known standard formed on the first blotter paper;
determining the number of pixels formed by the blotches of blood on the first blotter paper;
dividing the number of pixels of the blotches of blood on the first blotter paper by the pixel to surface area ratio to derive the value indicative of the bleeding volume of the person based on the first blotter paper.

13. The method of claim 12 wherein the determining steps and the multiplying steps are performed with a processor.

14. The method of claim 12 further comprising the step of receiving the value indicative of bleeding volume.

15. The method of claim 12 wherein the electronically imaging step includes the step of photographing the first blotter paper with the blotches of blood thereon.

16. The method of claim 12 further comprising the step of forming four lines of a predetermined length, the four lines configured into a square configuration, and wherein the four lines comprise the known standard.

17. The method of claim 16 further comprising the step of electronically transforming the four lines of the known standard from a skewed configuration due to the electronically imaging step to the square configuration.

18. The method of claim 17 further comprising the step of calculating a pixels per linear length based on the four lines.

19. The method of claim 12 wherein the imaging step, the determining steps and the multiplying steps are performed on a handheld electronic device.

20. The method of claim 19 wherein the handheld electronic device is a personal digital assistant.

21. The method of claim 12 wherein the determining the pixel to surface area ratio includes the step of aligning an electronic image of the standard sized first blotter paper to a predefined outline shown during the imaging step on a screen of an electronic device.

22. The method of claim 12 further comprising the steps of:
electronically imaging a single two dimensional view of the blotches of blood formed on a second blotter paper;
determining a pixel to surface area ratio based on a known standard formed on the second blotter paper;
determining the number of pixels formed by the blotches of blood on the second blotter paper;
dividing the number of pixels of the blotches of blood on the second blotter paper by the pixel to surface area ratio to derive the value indicative of the bleeding volume of the person based on the second blotter paper.

23. The method of claim 22 wherein the blotches of blood on the first and second blotter papers represents first and second control discs for a screening in vivo platelet function test.

24. The method of claim 22 wherein the blotches of blood on the first blotter paper represents a first control disc, and the blotches of blood on the second blotter paper represents a first drug disc for determining a value associated with a difference in bleeding volume before and after drug consumption.

25. An apparatus for processing a blotter paper with blotches of blood to derive a value indicative of a bleeding volume of a person, the apparatus comprising:
an electronic device with a program comprising the steps of:
electronically capturing a single two dimensional view of the blotches of blood formed on the blotter paper;
determining a pixel to surface area ratio based on a known standard formed on the blotter paper;
determining the number of pixels formed by the blotches of blood on the blotter paper;
dividing the number of pixels of the blotches of blood on the blotter paper by the pixel to surface area ratio to derive the value indicative of the bleeding volume of the person.

26. The apparatus of claim 25 wherein the electronic device is a computer, portable electronic device, personal digital assistant, a camera or combination thereof.

27. The apparatus of claim 25 wherein the electronic device has a screen and the program forms an outline of the blotter paper on the screen.

28. A method of processing a blotter paper with blotches of blood to derive a value indicative of a bleeding volume of a person, the method comprising the steps of:
receiving an electronically imaged single two dimensional view of the blotches of blood formed on a first blotter paper;
determining a pixel to surface area ratio based on a known standard formed on the first blotter paper;
determining the number of pixels formed by the blotches of blood on the first blotter paper;
dividing the number of pixels of the blotches of blood on the first blotter paper by the pixel to surface area ratio to derive the value indicative of the bleeding volume of the person;
delivering the value indicative of the bleeding volume of the person to a medical professional.

29. The method of claim 28 wherein the delivering step includes the step of emailing or providing a unique identifier to the medical professional so that the medical professional may look up the value indicative of bleeding volume of the person online.

30. A method of measuring a volume of fluid, gas or fine particulate, the method comprising the steps of:
providing a sheet of material which changes color when exposed to the fluid, gas or fine particulate, the degree of color change being proportional to a mass or volume of the fluid, gas or fine particulate;
exposing the sheet of paper to the fluid, gas or fine particulate;
determining the degree of the color change of the sheet of material; and
calculating the mass or volume of fluid, gas or fine particulate absorbed into the sheet of material.

31. The method of claim 30 wherein the sheet of material is a sheet of paper treated with a chemical which changes color when the chemical treatment comes in contact with the fluid, gas or fine particulate.

32. The method of claim 30 wherein the sheet of material is gas permeable and the exposing step comprises the step of flowing the gas through the sheet of material to expose the sheet of material and the chemical treatment to the gas.

33. The method of claim 30 wherein the exposing step comprises the step of absorbing fluid into the sheet of material.
